(19) United States
(12) Patent Application Publication
(10) Pub. No.: US 2008/0012264 A1
(43) Pub. Date: Jan. 17, 2008

(54) Cross country travel unit

(76) Inventor: Neta Ladani, Rosh HaAyin (IL)

Correspondence Address: Martin D. Moynihan;PRTSI, Inc., P.O. Box 16446, Arlington, VA, 22215, US

(21) Appl. No.: 11/822,644

(22) Filed: Jul. 9, 2007

(30) Foreign Application Priority Data
Jul. 13, 2006 (IL) 176861

(51) Int. Cl. B62K 5/00

(52) U.S. Cl. 280/237; 280/212; 280/239; 280/259

(57) ABSTRACT

A vehicle for cross-country use comprises a front, a middle and a rear wheel arranged in tandem, each wheel having an outer circumference, and a lowermost extent for the outer circumference, each wheel being arranged for contact with the ground at that lowermost extent; wherein the middle wheel is arranged such that a lowermost extent thereof is raised with respect to corresponding lowermost extents of the front and rear wheels.

### RELATED APPLICATION

This application claims the benefit of Israel Patent Application No. 176861 filed on Jul. 13, 2006, the contents of which are incorporated herein by reference.

### FIELD AND BACKGROUND OF THE INVENTION

The present invention relates to a unit suitable for wheeled transport over rough uneven terrain such as cross-country terrain.

Generally wheeled vehicles are designed for flat terrain. Most wheeled vehicles have some level of off-road ability depending on the extent to which the off-road terrain is or is not flat.

One of the issues in driving a wheeled vehicle over off-road terrain is loss of traction when certain of the wheels are not touching the ground, or the need for additional traction to drag the vehicle over protrusions such as boulders.

In motorized vehicles this issue is dealt with by applying drive to the front and rear wheels. Four wheel drive vehicles thus have at least some traction as long as at least one wheel is touching the ground, and one wheel can supply traction to assist passage of the other wheel over an obstacle.

Two-wheeled vehicles such as bicycles and motorcycles present mechanical problems in trying to apply traction to the front wheel.

U.S. Pat. No. 4,445,702 teaches a bicycle with a middle wheel which is generally raised and which can be lowered to be brought into contact with the ground to provide additional traction. However the bicycle assumes level ground and therefore is of no assistance with the above problem.

There is thus a widely recognized need for, and it would be highly advantageous to have, a development of a two-wheeled vehicle which is devoid of the above limitations.

### SUMMARY OF THE INVENTION

According to one aspect of the present invention there is provided a vehicle for cross-country use comprising:

a front, a middle and a rear wheel arranged in tandem, each wheel having an outer circumference, and a lowermost extent for said outer circumference, each wheel being arranged for contact with the ground at said lowermost extent;

wherein said middle wheel is arranged such that a lowermost extent thereof is raised with respect to corresponding lowermost extents of said front and said rear wheels.

Preferably, drive is applied to said middle wheel and one of said other wheels.

Additionally or alternatively, drive is applied to said middle wheel and said rear wheel.

Additionally or alternatively, forward drive is applied to said middle wheel.

Preferably, reverse drive is applied to said middle wheel.

There may be provided a switch for differential application of forward drive, reverse drive and forward and reverse drive respectively to said middle wheel.

In one embodiment, drive is applied from pedals.

Alternatively drive is applied from a motor. In the case of a moped, drive may be provided from a combination of motor and pedals.

Preferably, the lowermost extent of said outer circumference of said middle wheel is substantially fixed with respect to said vehicle.

In an embodiment, the middle wheel is raised by substantially 200 mm.

According to a second aspect of the present invention there is provided a vehicle for cross country use comprising:

front and rear wheels in tandem, and

a middle wheel located between said front and said rear wheels, a lowermost extent of said middle wheel being raised with respect to a line connecting lowermost extents of said front and rear wheels, thereby to ensure that said middle wheel is brought into contact with uneven ground to assist with traction.

Unless otherwise defined, all technical and scientific terms used herein have the same meaning as commonly understood by one of ordinary skill in the art to which this invention belongs. The materials, methods, and examples provided herein are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified diagram of a bicycle according to a first preferred embodiment of the present invention;

FIG. 2 is a simplified diagram of a switch for controlling the drive applied to the middle wheel;

FIG. 3 is a simplified diagram showing the assembly of the middle wheel with pedals according to a preferred embodiment of present invention;

FIG. 4 is another simplified diagram showing the assembly of the middle wheel and pedals, according to the embodiment of FIG. 3;

FIG. 5 is a simplified diagram illustrating the use of the bicycle of FIG. 1 for mounting a boulder, and showing the effective use of the middle wheel according to a preferred embodiment of the present invention.

FIG. 6 is a simplified diagram illustrating the use of FIG. 5 wherein the bicycle is slightly more advanced in its travel over the boulder.

### DESCRIPTION OF THE PREFERRED EMBODIMENTS

The present embodiments comprise an apparatus and a method for cross-country travel over rough surfaces. The apparatus comprises a bicycle with a driven middle wheel which is raised with respect to the other wheels so that it only engages the ground when the ground is particularly uneven and additional traction is required.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

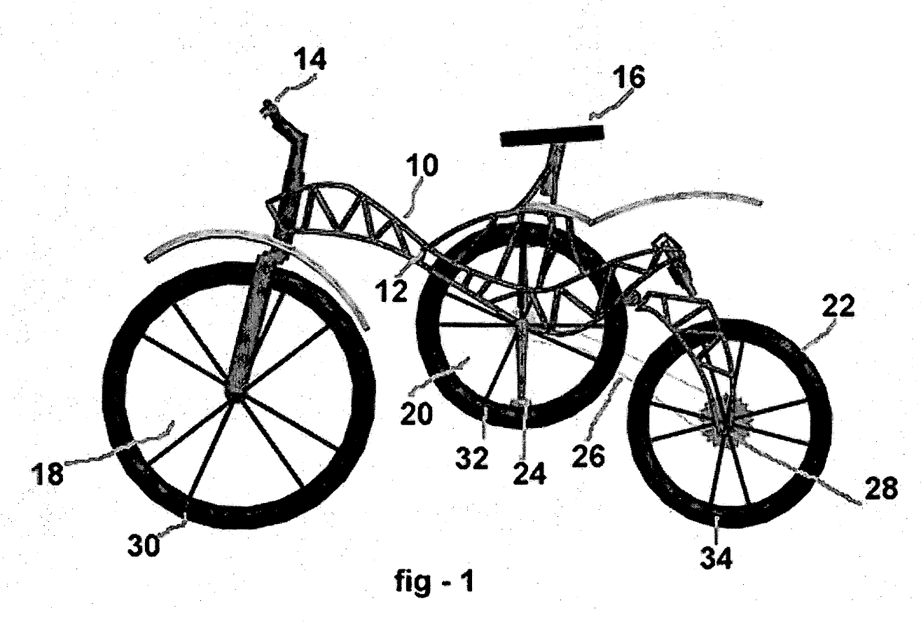

Reference is now made to FIG. 1, which illustrates a vehicle, in the form of a three-wheel bicycle, which is adapted for cross-country use, meaning for travel over off-road and non-level terrain. A bicycle is generally defined as a vehicle with two wheels tandem, handlebars for steering, a saddle seat, and pedals by which it is propelled. The term tandem is defined in this context as a group of two or more wheels arranged one behind the other or used or acting in conjunction. Bicycle 10 comprises a frame 12, handlebars 14, a seat 16, a front wheel 18, a middle wheel 20 and a rear wheel 22. The three wheels are arranged in tandem, and pedals 24, rotatably mounted on the frame 10, allow the rider to provide drive to the wheels. A chain 26 transmits drive from the pedals to rear wheel 22 via gears 28.

In the embodiment of FIG. 1, each of the three wheels 16, 18 and 20 has an outer circumference, labeled as 30, 32 and 34 respectively. At the lowermost extents of the outer circumferences, each wheel is arranged to come into contact with the ground. The middle wheel 20 is arranged such that its lowermost extent however is raised with respect to that of the other two wheels.

The extent to which the middle wheel is raised with respect to the others is a matter of design convenience. An example distance is 200 mm, selected because that is a typical height for a roadside curb.

The middle wheel is fixed to the frame so that it can only touch the ground when going over uneven ground. In principle the middle wheel could be fixed directly or through a suspension arrangement but in either event remains raised with respect to the other wheels, in particular when in contact with the ground.

Generally drive is provided from the pedals to the rear wheel via the chain. However drive is also provided to the middle wheel from the pedals.

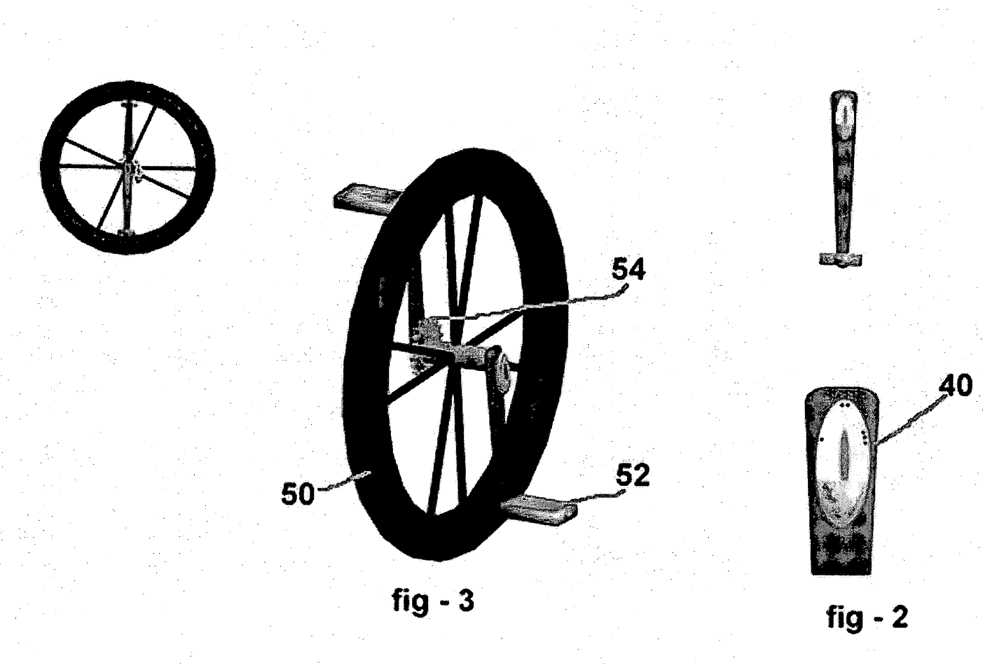

Reference is now made to FIG. 2, which illustrates a switch device for altering the way in which drive is provided to the middle wheel. Switch 40 is typically located on the handlebars or anywhere convenient to the user and allows the user to switch the drive of the middle wheel between three or four different states. Here three states are shown. The possible states are, transmit no drive to the middle wheel,—useful say for on-road use where the middle wheel is not required, transmit forward drive only to the middle wheel, transmit reverse drive only to the middle wheel, and transmit both forward and reverse drive to the middle wheel. The drive in each case may be transmitted through a suitably shaped gear.

It will be appreciated that in place of pedals, or in addition thereto, a motor may be supplied.

Reference is now made to FIG. 3, which illustrates middle wheel 50 attached to pedal 52 via gear 54. Gear 54 may be suitably shaped for the type of transmission required. Thus for forward only transmission the gear may have teeth which are abrupt in the forward direction but which are filed flat in the reverse direction.

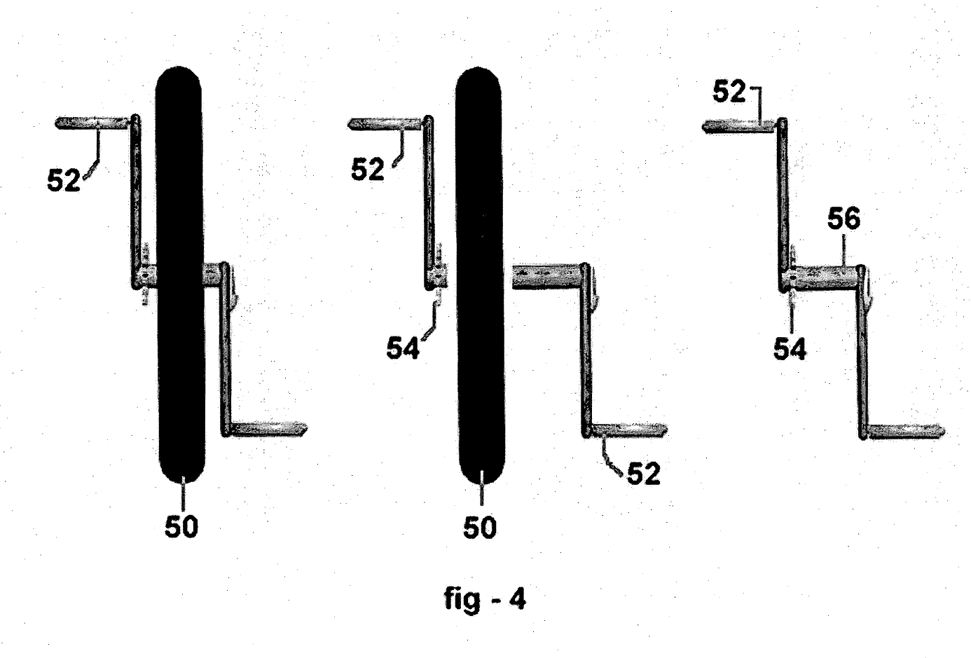

FIG. 4 illustrates the assembly of the pedals and gear about the middle wheel. Pedals 52 are located on shaft 56 which fits through and indeed forms the central axis of wheel 50. Gear 54 is engagingly located on shaft 56.

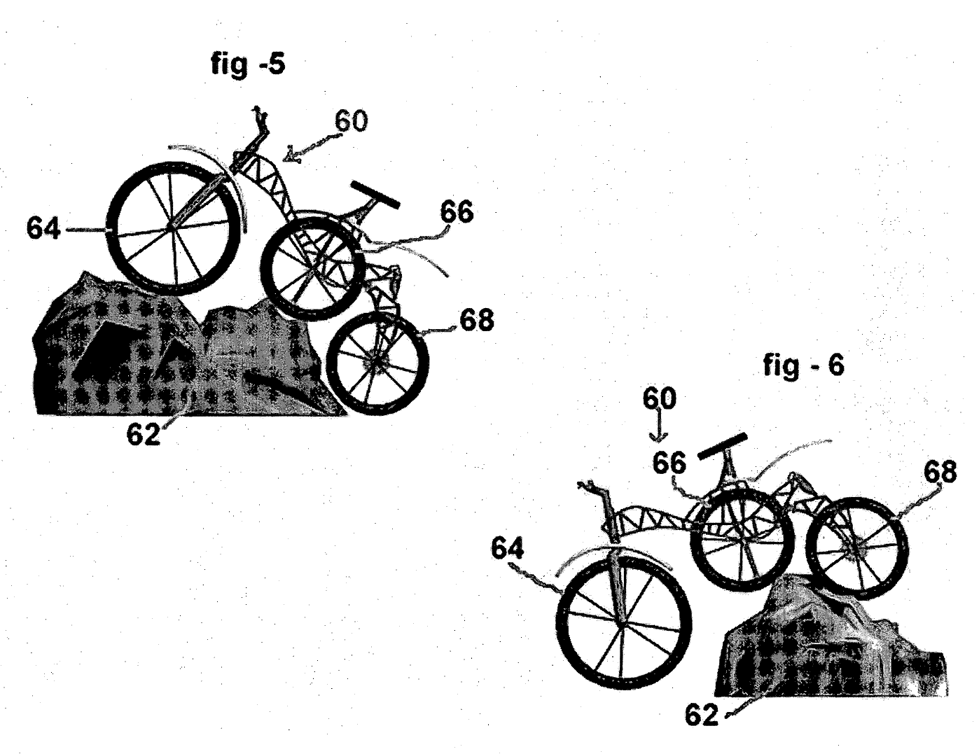

Reference is now made to FIG. 5, which illustrates a bicycle 60 according to preferred embodiments of the present invention in use attempting to ride over boulder 62. Front wheel 64 has reached the ground in front of the boulder. Middle wheel 66 is engaged on the surface of the boulder and rear wheel 68 is located on the ground behind the boulder. The rider is able to apply drive to both the middle and rear wheels in order to supply enough traction in order for the bicycle to mount the boulder. Without the help of the middle wheel, as soon as the rear wheel was to be raised into the air all traction would be lost.

Reference is now made to FIG. 6, which illustrates the embodiment of FIG. 5 at a later stage in passing over the same boulder. In this case the rear and middle wheels are on either side of the summit of the boulder. The middle wheel is able to provide traction to pull the rear wheel over the summit. Without a middle wheel the rear wheel would be liable to slip back.

It will be appreciated that while the above has been explained in respect of motorcycles and bicycles, the principle taught above may be extended to four wheel vehicles. Instead of talking of a middle wheel, a middle wheel axis with wheels at either end may be used. Alternatively a single middle wheel may be used as an additional drive wheel and located centrally on the vehicle.

It is expected that during the life of this patent many relevant devices and systems will be developed and the scope of the terms herein, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A vehicle for cross-country use comprising:
a front, a middle and a rear wheel arranged in tandem, each wheel having an outer circumference, and a lowermost extent for said outer circumference, each wheel being arranged for contact with the ground at said lowermost extent;
wherein said middle wheel is arranged such that a lowermost extent thereof is raised with respect to corresponding lowermost extents of said front and said rear wheels.

2. The vehicle of claim 1, wherein drive is applied to said middle wheel and one of said other wheels.

3. The vehicle of claim 1, wherein drive is applied to said middle wheel and said rear wheel.

4. The vehicle of claim 1, wherein forward drive is applied to said middle wheel.

5. The vehicle of claim 1, wherein reverse drive is applied to said middle wheel.

6. The vehicle of claim 1, further comprising a switch for differential application of forward drive, reverse drive and forward and reverse drive respectively to said middle wheel.

7. The vehicle of claim 6, wherein said drive is applied from pedals.

8. The vehicle of claim 1, wherein said drive is applied from a motor.

9. The vehicle of claim 1, wherein said lowermost extent of said outer circumference of said middle wheel is substantially fixed with respect to said vehicle.

10. The vehicle of claim 1, wherein said middle wheel is raised by substantially 200 mm.

11. The vehicle of claim 1, wherein said middle wheel is raised by substantially 200 mm.

12. A vehicle for cross country use comprising:
front and rear wheels in tandem, and
a middle wheel located between said front and said rear wheels, a lowermost extent of said middle wheel being raised with respect to a line connecting lowermost extents of said front and rear wheels, thereby to ensure that said middle wheel is brought into contact with uneven ground to assist with traction.

13. The vehicle of claim 12, wherein said middle wheel is raised by substantially the height of a roadside kerb.

14. The vehicle of claim 12, wherein said middle wheel is raised by substantially 200 mm.

15. The vehicle of claim 12, wherein drive is applied to said middle wheel and one of said other wheels.

16. The vehicle of claim 12, wherein drive is applied to said middle wheel and said rear wheel.

17. The vehicle of claim 12, wherein forward drive is applied to said middle wheel.

18. The vehicle of claim 12, wherein reverse drive is applied to said middle wheel.

19. The vehicle of claim 12, further comprising a switch for differential application of forward drive, reverse drive and forward and reverse drive respectively to said middle wheel.

20. The vehicle of claim 19, wherein said drive is applied from pedals.

21. The vehicle of claim 12, wherein said drive is applied from a motor.

22. The vehicle of claim 12, wherein said lowermost extent of said outer circumference of said middle wheel is substantially fixed with respect to said vehicle.
